(19) United States
(12) Patent Application Publication
(10) Pub. No.: US 2010/0114646 A1
(43) Pub. Date: May 6, 2010

(54) Method and System for Segmenting Customers for Marketing and Other Projects

(75) Inventors: Nate McIlwain, Columbus, OH (US); Carla Shroyer, Columbus, OH (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: ALLIANCE DATA SYSTEMS, INC., Columbus, OH (US)

(21) Appl. No.: 12/261,804

(22) Filed: Oct. 30, 2008

(51) Int. Cl. G06Q 30/00

(52) U.S. Cl. 705/10

(57) ABSTRACT

A customer segmentation technique automatically selects a customer score for customers from a plurality of predetermined customer scores during a daily processing sequence, allowing customer segmentation and performing marketing activities based on the customer score in the same daily processing sequence responsive to the customer score. The customer score encodes one or more customer status conditions that can be used by later functions in the daily processing sequence to guide marketing activities.

### TECHNICAL FIELD

The present invention relates to the field of consumer marketing, and in particular to a system and method for segmenting customers for marketing and other purposes.

### BACKGROUND ART

Typically, ongoing marketing communications to customers has involved manual processes that required substantial time and highly skilled personnel to select customer accounts to be used for marketing efforts. This causes the customer account information to be potentially outdated by the time it is used for the marketing effort, because the customer account information has changed.

### SUMMARY OF INVENTION

Other systems, methods, features, and advantages consistent with the present invention will become apparent to one with skill in the art upon examination of the following figures and detailed description. Such additional systems, methods, features, and advantages are intended to be within this description and within the scope of the invention.

In one embodiment, a method of customer segmentation, comprises (a) processing a plurality of customer event data for a plurality of customers; (b) automatically selecting a customer score from a plurality of predetermined customer scores for each of the plurality of customers responsive to the plurality of customer event data; (c) segmenting the plurality of customers responsive to their respective customer scores into a plurality of customer segments; and (d) performing a marketing activity corresponding to a customer segment of the plurality of customer segments, wherein some customers of the plurality of customers are members of a plurality of the plurality of customer segments, and wherein (a) through (d) are performed as a daily processing sequence by a computer system.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a high level block diagram illustrating a system for segmenting customers for marketing purposes according to one embodiment;

FIG. 2 is a flow chart illustrating a technique for segmenting customers for marketing purposes according to one embodiment;

FIGS. 3-7 are screen shots illustrating portions of a user interface of a system for segmenting customers according to one embodiment; and

FIG. 8 is a flow chart illustrating a technique for updating a score associated with a customer account according to one embodiment.

### DESCRIPTION OF EMBODIMENTS

An automated customer scoring and segmentation system according to the disclosed embodiments can allow much quicker selection of customer accounts that meet selection criteria, and also allow the scoring and segmentation to be performed automatically, reducing the skill levels necessary for generating the scoring.

The term database as used herein can refer to any technique for storing and accessing data, and no particular implementation is implied or required. In many cases, the database is implemented as a relational database, as that term is understood in the art, but any other convenient or desired technique and system for storing and accessing the data can be used. Similarly, the term application should be understood to refer to one or more computer software programs, without regard to the nature or type of the programs, or any implication as to the techniques required for invoking or executing the application.

Most large organizations needing to prepare marketing efforts based on credit accounts to on-going customers utilize daily processes known as batch processes because customer data are processed in large batches. Typically, earlier portions of the batch process or batch run involve posting and processing the current or a previous day's credit transactions, new account openings, account closings, and other account modifications or transactions related to the account. After the batch of customer account related data is processed, and associated databases updated, any marketing efforts that are to be created are generated at the end of the daily process to allow the marketing campaign to use the most up to date data in the various account databases.

Although transactions such as credit transactions are often collected in real time from retailers and other transactional data sources, practical processing needs typically do not allow real time posting of the transactional data, which are kept in pending status until the daily batch process is started, often in the evening of the day. Because these batch processes often run on tight schedules, organizations have typically limited the processing done on the data to that necessary to post the data to the various databases. Reporting and data selection can then be performed after the batch runs, in less time-constrained periods of the day.

Often, for example, manual processes are used by corporate staff to select customers for marketing efforts based on rolling criteria such as the customer's net sales over the last twelve months. Such a rolling twelve month calculation is often done by technically skilled people such as people in the corporate database group. Allowing these people to be deployed for analysis, modeling, and other more technical work and letting less skilled employees accomplish the same thing would be advantageous.

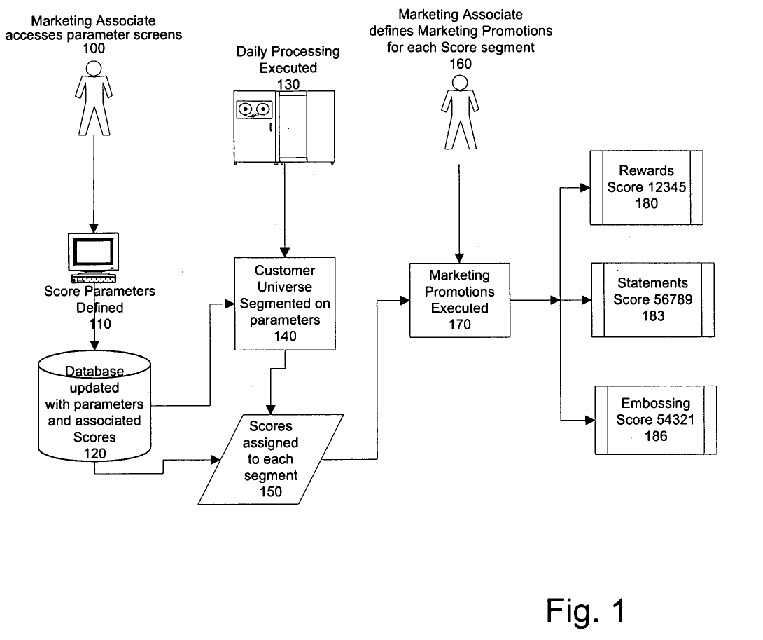

Turning now to FIG. 1, a block diagram illustrates a technique for segmenting customers according to one embodiment at a high level. In block 100, a marketing associate or other employee or contractor of the entity doing the customer segmentation accesses parameter screens for the software that performs the customer segmentation. The parameters control the assignment of scores to customers, and can be any useful or desired parameters. Then, in block 110, the associate defines or modifies the parameters for scoring. In block 120, a database is updated with the parameters, and the actual possible scores or a schema for generating the scores algorithmically. This database can, as described below, be any desired technique for storing the parameters and associated scores, including flat files and structured databases. Blocks 100-120 can be performed at any time prior to the actual segmentation. Although some embodiments may allow the marketing associate to update scoring parameters daily or even more often, typically these parameters will not change that frequently.

On a daily basis, or any desired schedule, batches of customer-related events and transactions are processed in a batch run in block 130 updating one or more databases of customer-related information. Then in block 140, the customers can be segmented into a plurality of possibly overlapping segments, based on the segmentation parameters stored in the database 120. Each customer in a segment is assigned a score in block 150, again based on the database 120. Where a customer is in more than one segment, a technique for combining scores for the various segments is used.

At another time a marketing associate or other employee or contractor defines marketing promotions that are to be performed for each segment in block 160. After scores are assigned in block 150, the marketing promotions are executed in block 170, resulting in various actions illustrated by example in blocks 180, 183, and 186. Block 180 represents the generation of rewards for a loyalty program, based on exemplary score 12345. Block 183 represents generating account statements with marketing information, based on exemplary score 56789. And block 186 represents embossing or creating new account instruments such as credit cards, based on exemplary score 54321. Other marketing promotions can be created and used with this technique.

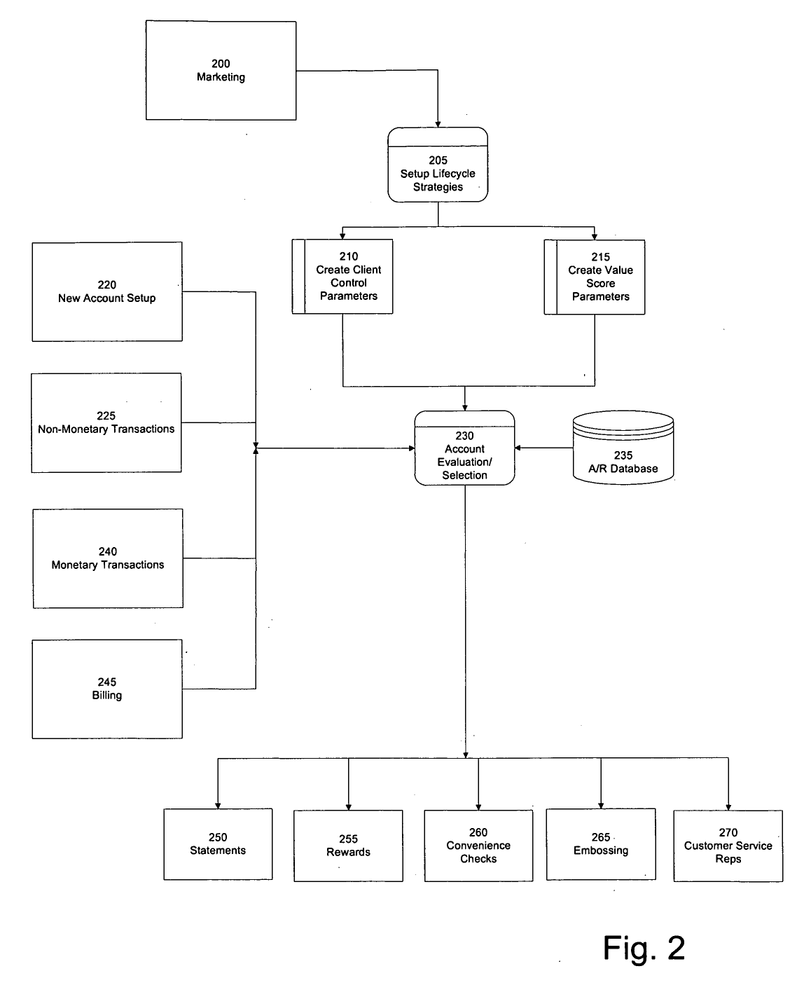

FIG. 2 is another block diagram, illustrating aspects of a technique for customer segmentation according to one embodiment, in FIG. 2 focusing on the various software applications involved in the technique. Application 200 is a marketing application allowing marketing associates, employees, or contractors to control the customer segmentation effort. Application 200 allows the marketing associate to set up life cycle strategies in application 205. As part of defining the life cycle strategies, the marketing associate can create or modify client control parameters 210 and scoring parameters 215.

In some embodiments, only scoring parameters 215 are used and client control parameters 210 are not used. Client control parameters 210 are used in some embodiments to allow different clients to specify different parameters for their customers. For example, one client may wish its customers to be rescored daily, while another client may request monthly rescoring. In one embodiment, some or all the scoring parameters 215 can also be client control parameters 210.

As part of the typically daily batch run, application 220 handles new account setup. Application 225 handles the processing of non-monetary transactions, such as the use of coupons or loyalty rewards. Application 240 handles the processing of monetary transactions, such ordinary customer purchases, and application 245 handles billing-related transactions such as a customer payment. These applications are exemplary and illustrative only and other applications can be executed. In addition, although shown as separate applications, applications 220, 225, 240, and 245 can be combined into any desired combination of applications. Similarly, any of applications 220, 225, 240, and 245 can be split into multiple applications if desired. These activity-tracking applications can post the details of customer transactions and other activity into one or more customer databases, such as the Accounts Receivable database 235.

Customer activity tracked in the applications 220, 225, 240, and 245 then triggers an account evaluation and selection application 230 that uses the client control parameters and scoring parameters to flag accounts that fall into the various customer segments defined by the life cycle strategies defined in application 205. The account information can be stored in the accounts receivable database 235 or any other suitable database.

Typically, at the end of the daily batch run but at least after the applications 220-245, the various customer segment applications 250-265 execute. As illustrated in FIG. 2, exemplary application 250 handles statement processing, such as putting marketing inserts into statements for accounts related to the relevant customer segments. Application 255 handles the generation of rewards in a loyalty program, and application 260 generates convenience checks. Application 265 generates embossing, such as the creation of new credit cards for customers, and application 270 supports customer service representatives, allowing the customer service representatives to market certain promotional activities to customers based on the customer score. As indicated above, applications 250-270 are exemplary and illustrative only and other applications can be executed as a result of the customer segmentation efforts, and these exemplary applications can be combined with each other or split into other applications as desired. Marketing applications 250-270 can be preexisting applications that are modified to use the score value. Although described above as marketing applications, they are not limited to marketing, but any activity that is useful or desirable to perform on one or more segments of customers can be performed.

The client control parameters 210 can include any convenient or desired parameters. In some embodiments, these parameters can include parameters such as whether the customer should receive paper statements, whether the customer has an email address, or whether to use the customer's account creation date for segmentation. The scoring parameters 215 in some embodiments include similar parameters, but can also include other parameters, such as the customer's birth month, annual net spending, or other desired parameters. The parameters listed above are merely illustrative and exemplary only, and any parameters that would be useful or desired for segmentation of the customers can be used.

In one embodiment, the result of the account evaluation/selection process is the assignment of a score value for each customer. The score value can be created to encode in the value information that can be interpreted by a customer service representative. For example, a customer who has recently opened an account and not yet made a purchase may be assigned a score value with a 9 in the thousands digit, i.e., 9xxxx, where the xxxx digits may encode other information about the customer, while a customer with a long term history of usage might be given a score of 8xxxx. A customer who only desires email communications can be given a score of x1xxx, while a customer getting paper communications can have a score of x2xxx. As will be clear to a person of skill in the art, these encodings can overlap, for example, using encodings described above, a customer with a long credit history on the account getting email communications only could have a score of 81xxx. These scores are exemplary and illustrative only, and other kinds of scoring coding can be used, some of which are not human interpretable. Although the score values given as examples above are five digit numeric values, some embodiments may use non-numeric scoring values and any number of characters can be used as desired. In some embodiments, there is no ranking of scores, i.e., a lower score value is not intended to indicate a better or worse customer relationship. In other embodiments, the assignment of a score does not depend on an encoding algorithm, but can be an arbitrarily or randomly assigned value. In general, however, the score is not the result of a mathematical scoring process. A default score value can be assigned to indicate the account does not qualify for any other score value.

A customer service representative using application 270 for dealing with a customer in some embodiments can see the customer's score, and use that score in order to guide the conversation with the customer. In other embodiments, the score will trigger other software applications used by the customer service representative to prompt the customer service representative with a selected selling tool for that customer. For example, the score may cause the customer service representative's screens to include narrative information to prompt the customer service representative's interaction with the customer.

In some embodiments, business rules can be used to control the scoring process of application 230. A customer can be locked into a score for a selected period of time, such as disallowing changes more than once a month, or the score can be allowed to change every time the scoring process runs. For example, with a new account, in one embodiment the score can be kept in an “account nurturing” status for an initial period, to avoid using their behavior during that period for segmentation, then begin to rescore the customer regularly thereafter. Different clients can request different scoring parameters and frequencies. One client can choose to rescore only at the end of the month, while another client could require rescoring daily. These client differences can be accommodated by use of the client control parameters 210.

Some embodiments can be configured with client control parameters 210 to only score customers of certain clients and not customers of other clients who do not want to use scoring. The scoring system can be configured to score only certain types of customers, for example, only customers with “gold” cards, or only customers with certain open date ranges, or with certain risks.

In some embodiments, score values are assigned a priority. As customer accounts are being funneled through one or more applications 230 to determine possible scores, a given customer may be eligible for multiple score values. The score value ultimately assigned to the customer is the score value with the highest priority. In some embodiments the technique for selecting the score value is to select a proposed score value based on a portion of the selection process. As the selection process continues, if a higher priority score value can be selected for that customer, that higher priority value replaces the previous score value. If another possible score value has the same priority, the score is not changed, for the first score value selected for that priority group is selected unless a score from a higher priority group becomes eligible for selection. In another embodiment, the last score value that becomes eligible for selection is the one chosen from that priority group.

Another embodiment first considers whether scores from the highest priority group can be selected for each customer. If no score from the highest priority group is selected, then the scores in the next highest priority group are considered, and so on until a score value is selected.

Other techniques for deciding which of a plurality of possible scores to select can be used. In some embodiments, for example, scores are ranked, and a score with a higher rank is selected over scores with lower ranks. Any desired technique for selecting the score for a customer can be used.

As indicated above, any particular score may encode multiple meanings into the score value. Applications segmenting customers can perform different actions based on the same score value. Some applications can consider the entire score value and other applications can consider only a portion of the score that encodes information meaningful for that application.

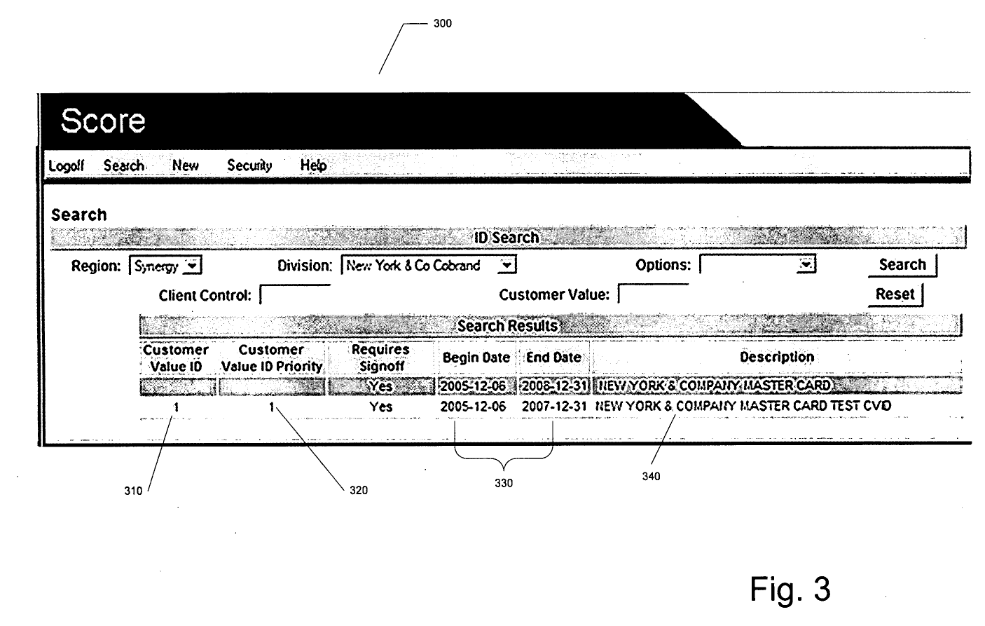

Marketing associates in most embodiments have a user interface that allows them to manipulate the client control parameters, score parameters, and obtain information about scores. FIG. 3 illustrates a screen for one embodiment, where the associate can search for scores. In this example, the result of the search is two records, one with a score value 310 of one and the score priority 320 of one. The score is valid between Dec. 6, 2005 and Dec. 31, 2007, and is described in the example as “New York & Company MasterCard Test Score” (340).

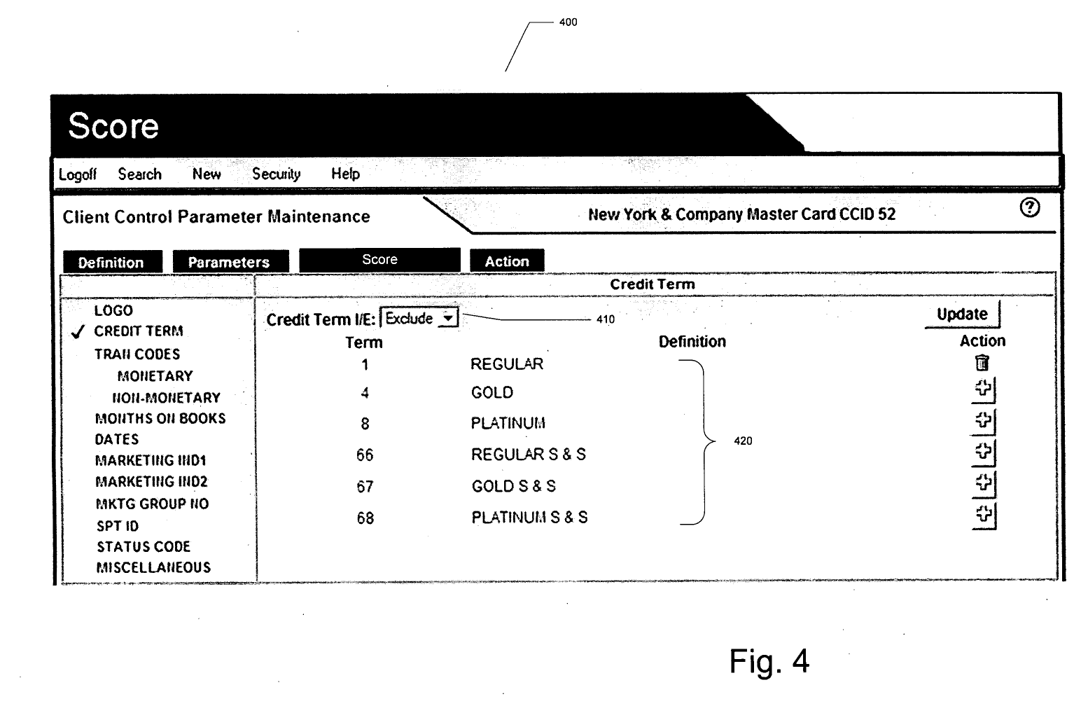

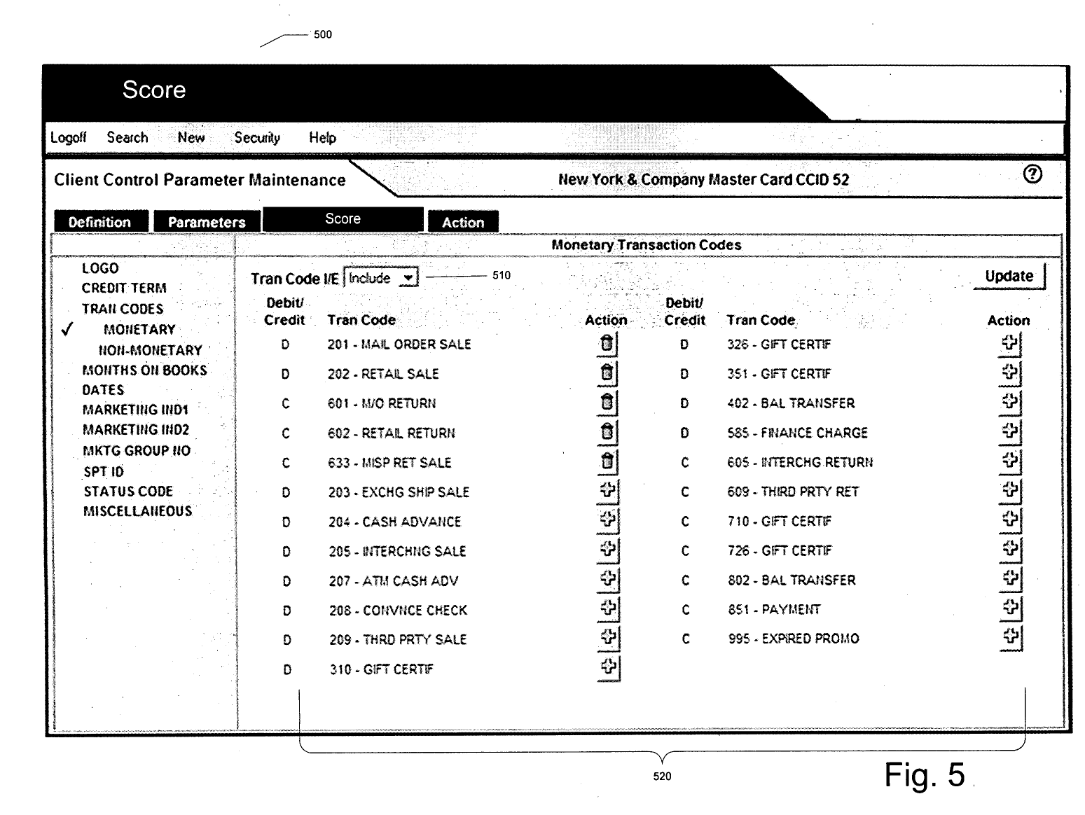

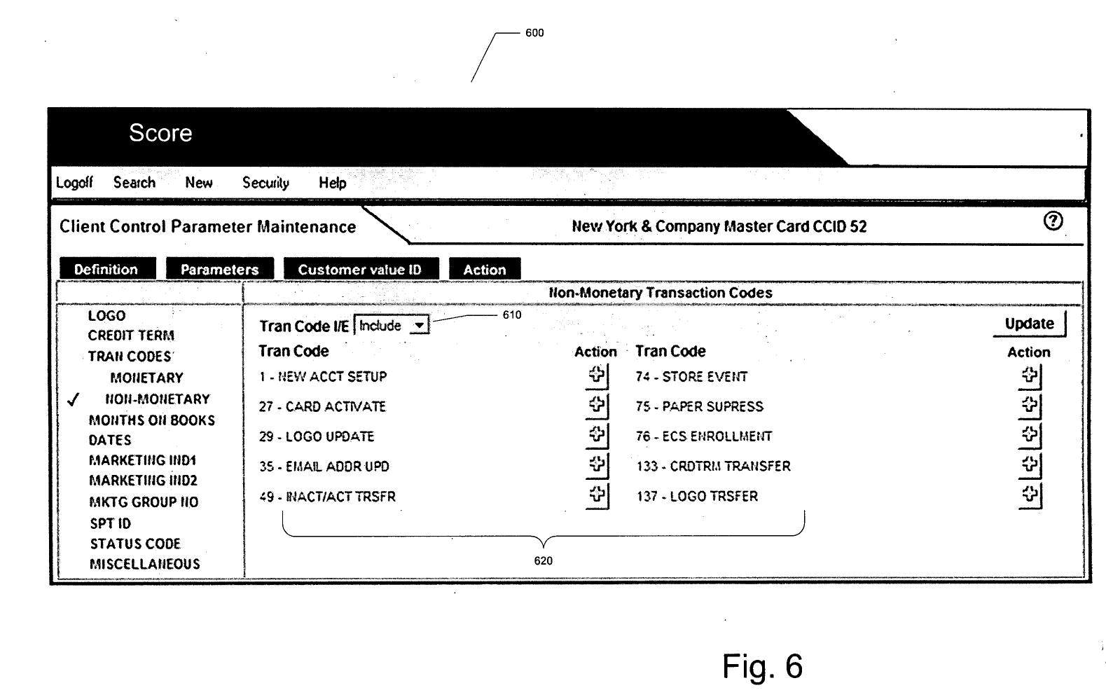

The user interface typically allows manipulation of client control parameters, such as the credit term parameters illustrated in screen 400 of FIG. 4. The marketing associate can include or exclude (410) accounts that match one or more of the credit terms 420. For example, the marketing associate could exclude all platinum cardholders using this parameter. Other parameters are illustrated in FIGS. 5 and 6. In FIG. 5, screen 500 illustrates the ability to include or exclude certain kinds of monetary transactions, identified by monetary transaction codes 528. For example, the associate using this screen 500 could include all transactions involving the monetary transaction code 520 that identifies the transaction as being a retail sale, and exclude mail order sales.

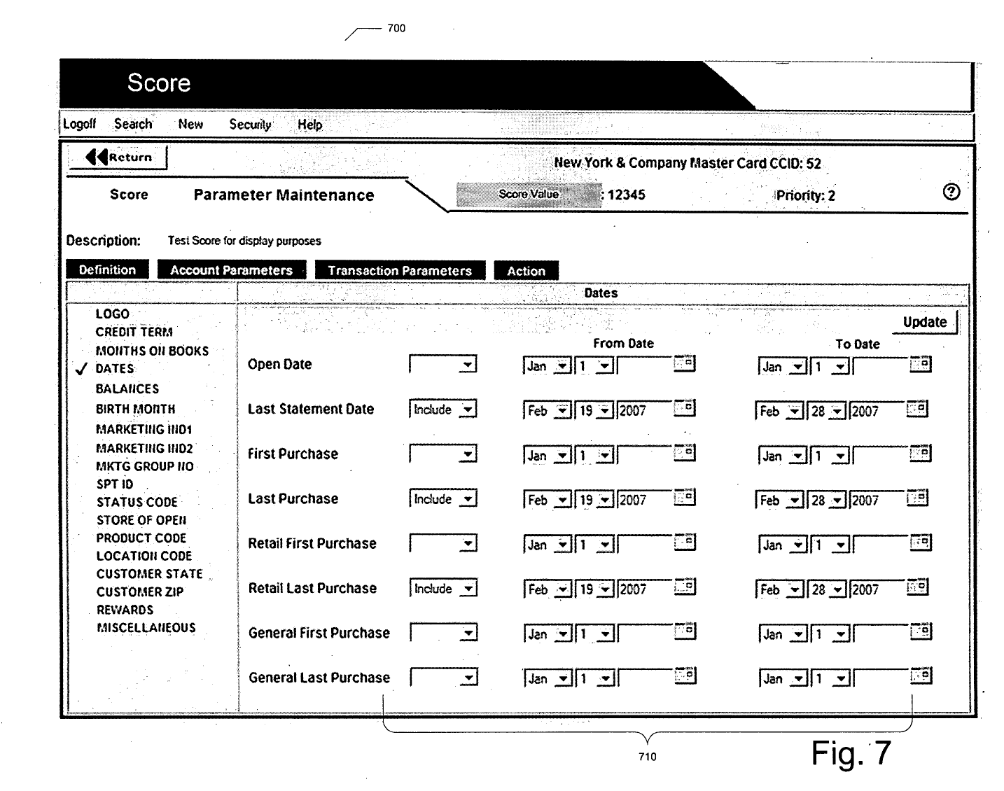

FIG. 6 illustrates a similar user interface screen 600 related to non-monetary transaction code 620 that can be included or excluded. For example, the associate can include (610) all non-monetary transaction identified by the transaction code 620 for a new account setup. Similar capabilities can be provided for score parameters, including screens similar to those shown for FIGS. 4-6, but in some embodiments including additional screens such as the screen 700, illustrated in FIG. 7, where a plurality of date related parameters 710 allow filtering accounts by one or more of a plurality of parameters.

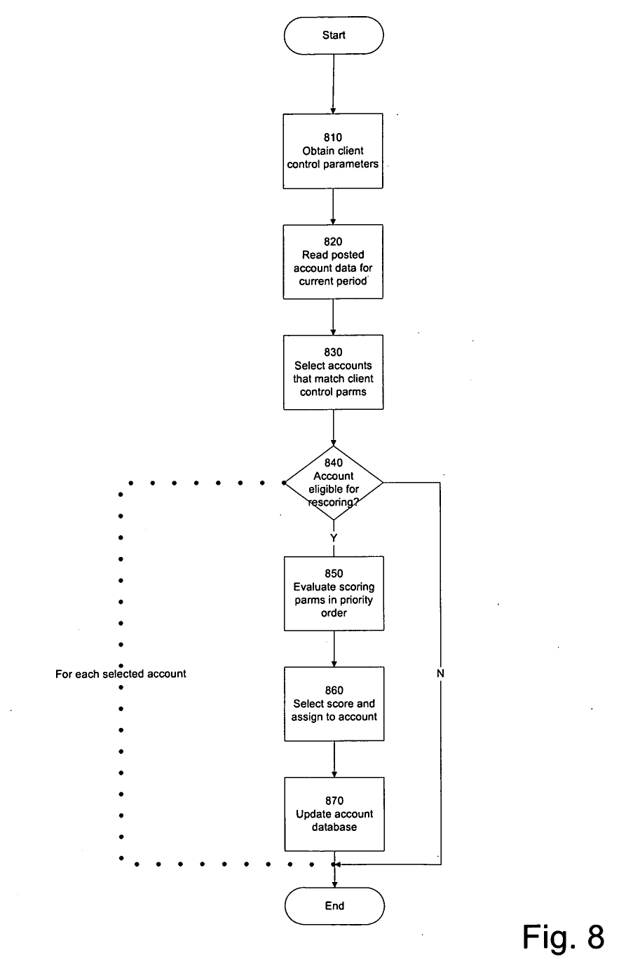

Turning to FIG. 8, a flow chart illustrates in more detail scoring processing for accounts according to one embodiment. In block 810, the scoring application obtains the client control parameters typically from a data base as described above. Then in block 620, the scoring application reads account data posted earlier in the batch run. Block 830 filters the accounts according to the client control parameters. Then each of the filtered accounts is considered for rescoring. In block 840, the application evaluates each account to see if it is eligible for updating the score. If not eligible, rescoring is skipped and the next account is reviewed. If the account is eligible for rescoring, then in block 850 the score to be assigned is selected. Then in block 870 the account database is updated with the revised or new score for the account. Blocks 840-870 are repeated for all accounts selected by block 830.

While certain exemplary embodiments have been described in details and shown in the accompanying drawings, it is to be understood that such embodiments are merely illustrative of and not devised without departing from the basic scope thereof, which is determined by the claims that follow.

We claim:

1. A method of customer segmentation, comprising:
(a) processing a plurality of customer event data for a plurality of customers;
(b) automatically selecting a customer score for each of the plurality of customers responsive to the plurality of customer event data;
(c) segmenting the plurality of customers responsive to their respective customer scores into a plurality of customer segments; and
(d) performing an activity corresponding to a customer segment of the plurality of customer segments,
wherein some customers of the plurality of customers are members of a plurality of the plurality of customer segments, and
wherein (a) through (d) are performed as a periodic processing sequence by a computer system.

2. The method of claim 1, further comprising:
grouping a plurality of predetermined customer scores into a plurality of groups, each group having a ranking value;
wherein (b) comprises:
if a customer qualifies for customer scores in more than one of the plurality of groups, selecting the customer score from the group with the highest ranking value.

3. The method of claim 1, further comprising:
grouping a plurality of predetermined customer scores into a plurality of groups, each group having a ranking value;
wherein (b) comprises:
if a customer qualifies for more than one of the customer scores of a first group, selecting one of the customer scores for which the customer qualifies.

4. The method of claim 3, further comprising:
replacing a selected one of the customer scores corresponding to a first group with a selected one of the customer scores corresponding to a second group with a higher ranking value than the first group.

5. The method of claim 3, further comprising:
ignoring any of the plurality of groups having a lower ranking value than the first group.

6. The method of claim 1, further comprising:
restricting a customer score for a customer of the plurality of customers from changing for a predetermined period of time.

7. The method of claim 1, further comprising:
restricting a customer score for a customer of the plurality of customers from changing until one or more predetermined events occur.

8. The method of claim 1, (b) comprising:
establishing a plurality of business rules;
automatically selecting the customer score responsive to the plurality of business rules.

9. The method of claim 1, further comprising:
restricting the customer score for a customer of the plurality of customers from changing according to a predetermined criteria.

10. The method of claim 9, wherein the predetermined criteria is a client-controlled criteria.

11. The method of claim 1, wherein each of the plurality of predetermined customer scores encodes one or more of a plurality of predetermined customer status conditions.

12. The method of claim 11, further comprising:
providing information to a customer service representative to allow decoding each of the plurality of predetermined customer scores to determine the encoded one or more predetermined customer status conditions.

13. The method of claim 11, further comprising:
Automatically decoding a customer score; and providing a narrative to a customer service representative responsive to the customer score.
